(19) United States
(12) Patent Application Publication
(10) Pub. No.: US 2015/0115149 A1
(43) Pub. Date: Apr. 30, 2015

(54) MASS DISTRIBUTION MEASUREMENT METHOD AND MASS DISTRIBUTION MEASUREMENT APPARATUS

(71) Applicant: CANON KABUSHIKI KAISHA, Tokyo (JP)

(72) Inventors: Naofumi Aoki, Nagoya-shi (JP); Masafumi Kyogaku, Yokohama-shi (JP); Kota Iwasaki, Atsugi-shi (JP)

(21) Appl. No.: 14/516,839

(22) Filed: Oct. 17, 2014

(30) Foreign Application Priority Data
Oct. 30, 2013 (JP) 2013-225694

(51) Int. Cl. H01J 49/00; H01J 49/40

(52) U.S. Cl. CPC H01J 49/0004; H01J 49/0031; H01J 49/40
USPC 250/282; 250/287

(57) ABSTRACT

Projection TOF mass spectrum distribution information is acquired by irradiating a first ionizing beam onto a surface of a specimen to acquire first mass spectrum distribution information on secondary ions generated from the specimen, irradiating a second ionizing beam onto the same surface to acquire second mass spectrum distribution information on secondary ions generated from the specimen, and correcting the second mass spectrum distribution information on the basis of the first mass spectrum distribution information.

### BACKGROUND OF THE INVENTION

1. Field of the Invention

The present invention relates to a method of acquiring mass distribution information on a specimen. The present invention also relates to an apparatus capable of displaying the acquired mass distribution information as a mass distribution image.

2. Description of the Related Art

Imaging mass spectrometry is realized by applying mass spectrometry and the development of imaging mass spectrometry is under way as analysis method of comprehensively visualizing two-dimensional distribution information on a large number of substances that constitute an analysis specimen, which may typically be a piece of biological tissue. Mass spectrometry is a technique of ionizing a specimen by irradiating the specimen with a laser beam or primary ions, isolating the ionized specimen (secondary ions) by utilizing the mass-to-charge ratio m/z (m: mass of secondary ion, z: valence of secondary ion) and obtaining a spectrum of secondary ions that is expressed on a graph having a horizontal axis representing the m/z ratios and a vertical axis representing the signal intensities of detected secondary ions. The two-dimensional distribution of signal intensities of secondary ions that correspond to respective m/z peak values can be obtained by way of two-dimensional mass spectrometry of the surface of the specimen and hence two-dimensional distribution information (mass imaging) on the substances that correspond to the respective secondary ions can be obtained.

Imaging mass spectrometry that makes use of a time-of-flight ion analysis unit for isolating and detecting ions of an ionized specimen on the basis of differences of time-of-flight down to a detector is mainly in use today. Known techniques of ionizing a specimen include Matrix Assisted Laser Desorption/Ionization (MALDI), which is a technique of ionizing a specimen, to which a matrix has been applied or with which a matrix has been mixed, by irradiating the specimen with a pulsed and finely converged laser beam, and Secondary Ion Mass Spectroscopy (SIMS), which is a technique of ionizing a specimen by irradiating a specimen with a primary ion beam. Of the known imaging mass spectrometries, those that utilize MALDI or the like as ionizing technique have already been widely utilized to analyze biological specimens including proteins and lipids. However, with the MALDI technique, the spatial resolution is limited to about tens of several micrometers because of the principle of utilization of matrix crystal on which it is based. To the contrary, Time of Flight-Secondary Ion Mass Spectroscopy (TOF-SIMS), which is realized by combining an ion irradiation type ionization technique and a time-of-flight type ion detection technique, can provide a high spatial resolution of the order of sub-microns and hence has been drawing attention in recent years as mass spectrometry technique that is applicable to imaging mass spectrometry.

With known imaging mass spectrometries that employ any of the above-described techniques, two-dimensional mass spectrum distribution information is obtained by scanning a beam for ionization and sequentially conducting mass analyses for a large number of minute measurement areas. However, scanning type TOF-SIMS as described above is accompanied by a problem that a long period of time has to be spent to acquire a mass image over a broad area.

Imaging mass spectrometry using a two-dimensional collective detection (projection) technique has been proposed to dissolve the above-identified problem. With this method, the components on a large area of a specimen surface are collectively ionized and the two-dimensional distribution of generated secondary ions is straightly projected onto a detection unit so that mass information on the specimen components and the two-dimensional distribution thereof can be acquired at a time to remarkably reduce the measurement time.

With TOF-SIMS, the axis of the optical system that the mass spectrometry section of the mass spectrometry system includes is arranged so as to be perpendicular relative to the substrate surface and hence an ionizing beam is normally made to strike the substrate obliquely in order to avoid interference with the mass spectrometry section.

However, with projection type TOF-SIMS, a pulsed primary ion beam having a spread (having a relatively large beam cross section) is made to irradiate a specimen so as to ionize the specimen over a large area at a time (and generate secondary ions). Therefore, if the primary ion beam is made to strike the specimen obliquely, in-surface variations of arrival time of primary ions arise (in the irradiation area). Then, as a result, there also arise in-surface variations of time of secondary ion generation from the specimen to give rise to a problem of a fall of mass resolution.

Japanese Patent Application Laid-Open No. 2011-149755 proposes a technique of improving the mass resolution of the observed spectrum by dividing an arbitrary area of the spectrum to be measured into a plurality of points of measurement, obtaining the time-of-flight spectrum of secondary ions at each of the points of measurement, correcting the variance of flight distance and hence the variance of flight time attributable to differences of height of the specimen surface for each point of measurement and subsequently adding up the spectrums.

With known projection type imaging mass spectrometry apparatus, variations of arrival time of primary ion at the specimen surface take place due to the above-described oblique incidence of ionizing beam. Then, there arises (in-surface) variations of secondary ion generation time in the area of measurement attributable to the variations of arrival time. As such variations take place, there also arise (in-surface) variations of time of secondary ion detection to consequently lower the mass resolution to give rise to a problem that the two-dimensional mass distribution information in the area of measurement cannot be correctly observed. Thus, the above-described variance of secondary ion generation time needs to be corrected to obtain accurate mass distribution information in the area of measurement.

To correct the in-surface variance, normally, the mass spectrum needs to be corrected at each arbitrary in-surface point. With known calibration techniques, peaks for which m/z is known need to be selected at least at two or more than two points and the correction coefficient is computationally determined on the basis of the m/z of the selected peaks to obtain m/z information at other peaks. Therefore, the in-surface variance cannot be corrected if there are not peaks at two or more than two points for which m/z can definitely be determined at all (in-surface) measurement points in the area of measurement.

Additionally, the signal intensities of the plurality of peaks for which m/z is known are not equal and hence a plurality of peaks with known m/z can hardly be detected by automatic detection.

With the method described in Japanese Patent Application Laid-Open No. 2011-149755, variations of time-of-flight of secondary ion with regard to each point of measurement on the specimen surface is grasped as variations of flight distance and the variance of flight distance is corrected on the basis of variance of rising edge of arbitrary peaks. However, the method described in Japanese Patent Application Laid-Open No. 2011-149755 deals with variance of flight distance of secondary ions attributable to the unevenness of the specimen surface as target of correction and variance of time of arrival of primary ion at the substrate (variance of time of second ion generation) is assumed to be non-existent and hence disregarded. In other words, this method does not assume the existence of variations of secondary ion generation time due to oblique incidence of primary ions in a two-dimensional collective mass spectrometry type mass spectrometry apparatus and hence the method of Japanese Patent Application Laid-Open No. 2011-149755 can hardly be applied to correction of such variance.

### SUMMARY OF THE INVENTION

According to the present invention, the above-identified problems are dissolved by providing a projection TOF mass spectrum distribution information acquisition method including: a first step of irradiating a first ionizing beam onto a surface of a specimen and acquiring first mass spectrum distribution information on secondary ions generated from the specimen as a result of irradiation of the first ionizing beam; a second step of irradiating a second ionizing beam onto the surface of the specimen and acquiring second mass spectrum distribution information on secondary ions generated from the specimen as a result of irradiation of the second ionizing beam; and a third step of correcting the second mass spectrum distribution information on the basis of the first mass spectrum distribution information; the third step including correcting a delay distribution of secondary ion generation times in the second mass spectrum distribution information on the basis of the first mass spectrum distribution information.

In another aspect of the present invention, the above identified problem is dissolved by providing a projection TOF mass distribution measurement apparatus including: a specimen stage for receiving a specimen to be mounted thereon; a first ionizing beam irradiation unit for irradiating a first ionizing beam onto the specimen mounted on the specimen stage; a second ionizing beam irradiation unit for irradiating a second ionizing beam onto the specimen mounted on the specimen stage; a secondary ion detection unit for separating secondary ions generated from the specimen as a result of irradiation of the ionizing beams by mass-to-charge ratio and two-dimensionally detecting the secondary ions; a mass spectrum distribution information acquisition unit for acquiring mass spectrum distribution information from a secondary ion detection signal output from the secondary ion detection unit; a mass spectrum distribution information correction unit for correcting the mass spectrum distribution information output from the mass spectrum distribution information acquisition unit; and an output unit for outputting mass spectrum distribution information, the apparatus being configured: to acquire first mass spectrum distribution information by irradiation of the first ionizing beam; acquire second mass spectrum distribution information by irradiation of the second ionizing beam; correcting a delay distribution of secondary ion generation times in the second mass spectrum distribution on the basis of the first mass spectrum distribution information; and output the corrected second mass spectrum distribution information from the output unit.

Thus, a mass spectrum distribution information acquisition method and a mass distribution measurement apparatus according to the present invention can correct the fall of mass resolution due to inconsistency of data on the secondary ion generation times so that highly reliable images can be obtained by mass spectrometry imaging.

Further features of the present invention will become apparent from the following description of exemplary embodiments with reference to the attached drawings.

### BRIEF DESCRIPTION OF THE DRAWINGS

FIG. 1 is a schematic illustration of an exemplary apparatus configuration for executing the method of the present invention.

FIG. 2 is a schematic illustration representing variation of arrival time of a primary ion beam at a specimen surface with a projection imaging mass spectrometry.

FIG. 3 is a flowchart illustrating the steps of the method of the present invention.

FIGS. 4A, 4B and 4C are a schematic illustration of an example of the present invention.

### DESCRIPTION OF THE EMBODIMENTS

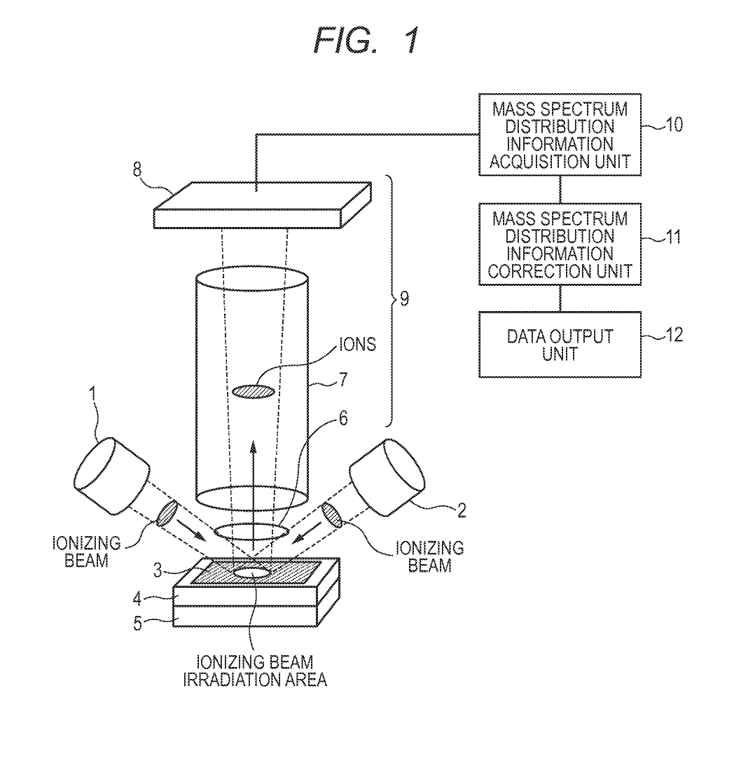

Now, the method of the present invention and the configuration of an apparatus that can suitably be used to execute the method will be described below by referring to FIG. 1. FIG. 1 is a schematic illustration of an exemplary apparatus for executing the method of the present invention, representing the configuration thereof. While the present invention will be described below by way of an embodiment thereof, the present invention is by no means limited by the embodiment.

The apparatus illustrated in FIG. 1 includes a projection TOF secondary ion detection unit 9, a first ionizing beam irradiation unit 1 and a second ionizing beam irradiation unit 2, each of the first and second ionizing beam irradiation units 1 and 2 being adapted to irradiate an ionizing beam having a certain thickness toward the surface of a specimen 3. The apparatus further includes a mass spectrum distribution information acquisition unit 10 for acquiring mass spectrum distribution information from the secondary ion detection signal output from the secondary ion detection unit 9, a mass spectrum distribution information correction unit 11 for correcting the mass spectrum distribution information output from the mass spectrum distribution information acquisition unit and an output unit 12 for outputting the results of correcting the mass spectrum distribution information.

Specimen 3 is a solid. Any of semiconductor circuits, organic compounds, inorganic compounds and biological specimens can be selected as specimen for the purpose of the present invention. The specimen 3 is rigidly secured onto substrate 4 having a substantially planar surface. The substrate 4 is mounted onto specimen stage 5. The specimen stage 5 has a translation mechanism so that any arbitrary area on the specimen 3 can be selected as measurement target area by driving the specimen stage 5 to move in X and Y directions.

Generally, with scanning type TOF-SIMS, a pulsed ionizing beam with a diameter of about 1 μm or less is used as an ionizing beam (primary ion beam). On the other hand, with the mass distribution analysis method according to the present invention, which is a projection method, a pulsed ionizing beam that has a two-dimensional width in a direction orthogonal to the travelling direction of the beam is employed in order to additionally detect information on the two-dimensional positions of ions generated from the specimen (secondary ions). In other words, an ionizing beam to be used for the purpose of the present invention can be regarded as a group of particles that is spatially broadened to a certain extent to represent a quasi-disk-shaped or quasi-cylinder-shaped profile as a whole. The irradiation area of an ionizing beam on the specimen surface is determined on the basis of the size of the area of measurement. When, for example, an area that includes a plurality of cells is selected as area of measurement of a biological specimen, an area having a side of tens of several micrometers to several millimeters will be selected as irradiation area.

The first ionizing beam and the second ionizing beam are emitted as pulsed beams, in which each pulse has a very short duration, and irradiated toward the specimen 3. Upon receiving the irradiated ionizing beams, secondary ions are generated from the surface of the specimen surface. The ionizing beams are so arranged as to strike the specimen surface in an oblique direction relative to the surface of the substrate 4 in order to avoid interference with the ion optical system that the ion detection unit includes.

A first ionizing beam is in principle faster than a corresponding second ionizing beam. When, for example, a primary ion beam is employed for the second ionizing beam, a pulsed laser beam or a pulsed electron beam may be used for the first ionizing beam. The travelling velocity of the first ionizing beam is preferably such that the variations of flight time of the ionizing beam that arises due to the variations of the length of the route of flight of the ionizing beam can be disregarded. More specifically, the travelling velocity is preferably not less than 1×10⁶ m/s. Alternatively, both the first and second ionizing beams may be pulsed ion beams. If such is the case, the two pulsed ion beams may be formed by using respective ion species that differ from each other or, alternatively, may be ion beams of the same ion species. If the two pulsed ion beams are ion beams of the same ion species, a same ionizing beam irradiation unit may be used for the first ionizing beam irradiation unit 1 and the second ionizing beam irradiation unit 2. Then, the ionizing beam irradiation unit needs to be operated so as to make the velocity of the first ionizing beam greater than that of the second ionizing beam.

The second ionizing beam is a beam having an ability of ionizing the specimen higher than the comparable ability of the first ionizing beam. For example, metal ions such as ions of bismuth, those of gallium or those of gold, or metal cluster ions, or gas cluster ions such as Ar cluster ions may preferably be used. Cluster ions are particularly effective to organic materials such as biological specimens because they provide an effect of alleviating the possible damage to the specimen. Preferable examples of cluster ions include cluster ions of gold, those of bismuth, those of xenon or those of argon, fullerene ions that are carbon based cluster ions, and water-based cluster ions. Water-based cluster ions is the generic name of clusters, including water cluster ions, formed by using a material such as water or aqueous solution and cluster ions formed by using a mixture of water molecules and other molecules.

The secondary ion detection unit 9 is constructed by using an extraction electrode 6 for accelerating secondary ions generated from a specimen as a result of irradiation of ionizing beams, a time-of-flight type mass spectrometry section 7 in which accelerated secondary ions fly at a constant speed and a two-dimensional ion detection section 8. Secondary ions that are generated from a specimen pass through the mass spectrometry section 7, maintaining the positional relationship of the secondary ions that is observed at the positions of generations of secondary ions on the surface of the specimen 3, and then are detected by the two-dimensional ion detection section 8.

The extraction electrode 6 and the substrate 4 are arranged at respective positions that are separated by a gap of about 1 to 10 mm and voltage V_{d} is applied to the gap in order to extract secondary ions. V_{d} is between about 100V and about 10kV, which may be either a positive voltage or a negative voltage. Secondary ions having mass m are accelerated by the voltage V_{d} before they enter the mass spectrometry section 7. A plurality of electrodes (not illustrated) for constructing a projection type optical system may appropriately be arranged downstream relative to the extraction electrode 6. These electrodes provide a converging effect of limiting the spatial broadening of secondary ions and a magnifying effect and any magnifying power can be arbitrarily selected by changing the voltage that is applied to the electrodes.

The mass spectrometry section 7 is constructed by a cylindrical member (mass spectrometer tube), which is generally referred to as flight tube. There is no electric potential gradient in the inside of the flight tube and hence secondary ions fly at a constant speed in the flight tube. Since the time-of-flight is proportional to the square root of m/z (m: mass of secondary ion, z: valence of secondary ion), the time-of-flight can be measured from the difference between the time of generation of a secondary ion and the time of detection of the secondary ion. From the viewpoint of improving the mass resolution, the use of a longer flight tube is advantageous. In the case of projection type, the magnifying power can be raised with ease by making the flight tube longer. A long flight tube is also advantageous for raising the spatial resolution, although the use of a long flight tube can make the entire apparatus bulky. By taking these factors into consideration, the length of the flight tube is preferably within the range extending between 1,000 mm and 3,000 mm.

The secondary ions that have passed through the mass spectrometry section 7 is projected onto the two-dimensional ion detection section 8 and the secondary ion detection signal obtained at the two-dimensional ion detection section 8 is sent to the mass spectrum distribution information acquisition unit 10. The mass spectrum distribution information acquisition unit 10 outputs a signal in which the detection intensity and the position on the two-dimensional detection section are associated for each ion. In other words, the signal is output as three-dimensional data that provide spectrum information for each position (mass spectrum distribution information). A projection adjustment electrode (not illustrated) that operates to construct an ion lens for adjusting the projection magnifying power may be arranged between the two-dimensional ion detection section 8 and the mass spectrometry section 7.

The two-dimensional ion detection section 8 may have any configuration so long as it can output information on the times and the positions of ion detections along with the detected intensities. For example, the two-dimensional ion detection section 8 may be constructed by combining a micro channel plate (MCP) and a two-dimensional photo detector, which may be a fluorescent plate or a charge-coupled device (CCD). By using a CCD detector that is normally employed for an ultra-high speed camera, images can be picked up on a time division basis by means of a shutter that operates at high speed. Then, images of ions whose arrival times at the detector can be picked up separately and individually for each image pickup frame so that mass-separated ion distribution images can be collectively obtained at a time. Besides, an MCP and a two-dimensional detector that can record the positions of electron detections along with detection times can be combined for use. For example, a delay line detector that employs a wire for detection of electrons or a semiconductor array detector that can record the arrival times of electrons for each pixel may be used.

Operation

Now, the effect and the principle of the information acquisition method of the present invention will be described below.

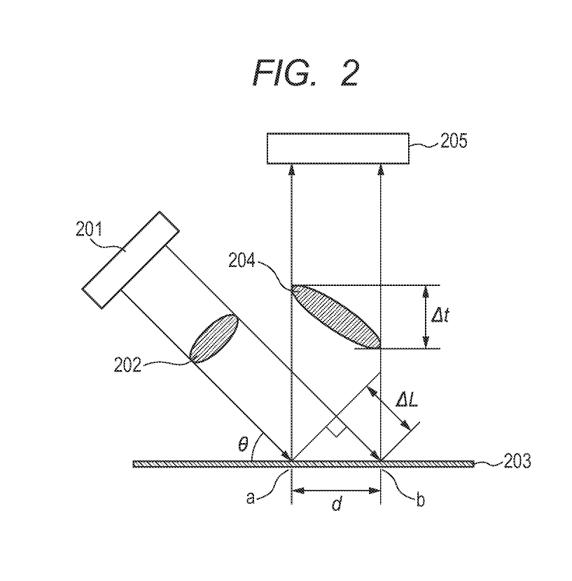

Firstly, in-surface variations of secondary ion generation time in a surface area of a specimen will be described by referring to FIG. 2. Such variations are observed when an ionizing beam (primary ion beam) having a certain thickness and emitted from an ionizing beam irradiation unit 201 obliquely strikes the specimen surface 203.

Note that d is not necessarily the largest distance between two points at which primary ions respectively arrive as viewed in the direction of incidence of primary ions (the direction projected onto the specimen surface that can be regarded as horizontal plane) and may simply be the distance between arbitrary two points in the area of irradiation as viewed in the direction of incidence of primary ions. Assume that the angle formed by the specimen surface 203 and the ionizing beam, more specifically, the angle formed by the specimen surface 203 and the ionizing beam striking either point a or point b (or some other arbitrary point), is θ. From the geometrical relationship, the difference of travelling distances ΔL of the ionizing beam between when the ionizing beam strikes point a and when the ionizing beam strikes point b on or near the specimen surface is expressed by ΔL=d*cosθ. If the velocity of the ionizing beam at the time when the ionizing beam strikes the specimen surface is V, the difference of arrival time Δt of primary ion between the time when a primary ion strikes point A and the time when a primary ion strikes point B, is expressed by Δt=ΔL/V.

Now, the influence of in-surface variations of primary ion arrival time when the ionizing beam obliquely strikes the specimen surface on the results of mass spectrometry will be described below also by referring to FIG. 2. The difference of arrival time At between two primary ions 202 arriving at the specimen surface 203 is exactly the same as the time difference of ion generation between the corresponding two secondary ions 204. In other words, there arises a time difference At of arrival time at the detection surface of the secondary ion detection section 205 between the two secondary ions 204 having the same mass m (or mass-to-charge ratio m/z, where z: valence of secondary ion) generated with a time difference Δt, of which one is generated at point a and the other is generated at point b. Thus, the measured values of time-of-flight of the two secondary ions involve Δt. In other words, a maximum time difference At of time-of-flight arises among ions having an arbitrary mass of m. All in all, “variance” of secondary ion detection time involving a maximum value of Δt arises between measurement point a and measurement point b.

The relationship between the mass of secondary ion m and the time-of-flight of secondary ion t in the flight tube is expressed by m=2 zeV_{acc}* (t/(L_{tube})², where V_{acc} is the voltage applied to secondary ions, L_{tube} is the length of the flight tube, e is the elementary quantum of electricity and t is the time-of-flight. Differently stated, the result obtained by mass separation involves ambiguity of Δm that corresponds to the difference of time-of-flight Δt. Then, because of the ambiguity, there can arise a fall of mass resolution of several times of μ (u: unified atomic mass unit) depending on the condition of emission of primary ions and the size of the beam irradiation area.

The two-dimensional ion detection section 8 (205) observes the distribution of the secondary ions that have got to the detector at respective positions corresponding to the points of measurement. Therefore, if the secondary ions that have arrived at the detector represent in-surface variations, the signals of some of the secondary ions having the mass of m may be lost and/or the signals of ions having a mass that maximally differs from m by Δm may be mixed with the proper signals and detected with the proper signals. Then, as a result, the mass distribution may not be observed correctly.

In view of the above-identified possible problems, with a mass distribution analysis apparatus according to the present invention, the first mass spectrum distribution information is acquired by irradiation of a first ionizing beam and then the second mass spectrum distribution information is acquired by irradiation of a second ionizing beam. Thereafter, arrival time distribution information of the second ionizing beam at the specimen (secondary ion generation time distribution information) is determined from the difference between the first mass spectrum distribution information and the second mass spectrum distribution information and the delay distribution of secondary ion generation time in the second mass spectrum distribution information is corrected on the basis of the arrival time distribution information. Then, as a result, a highly reliable mass distribution image can be obtained.

Embodiment

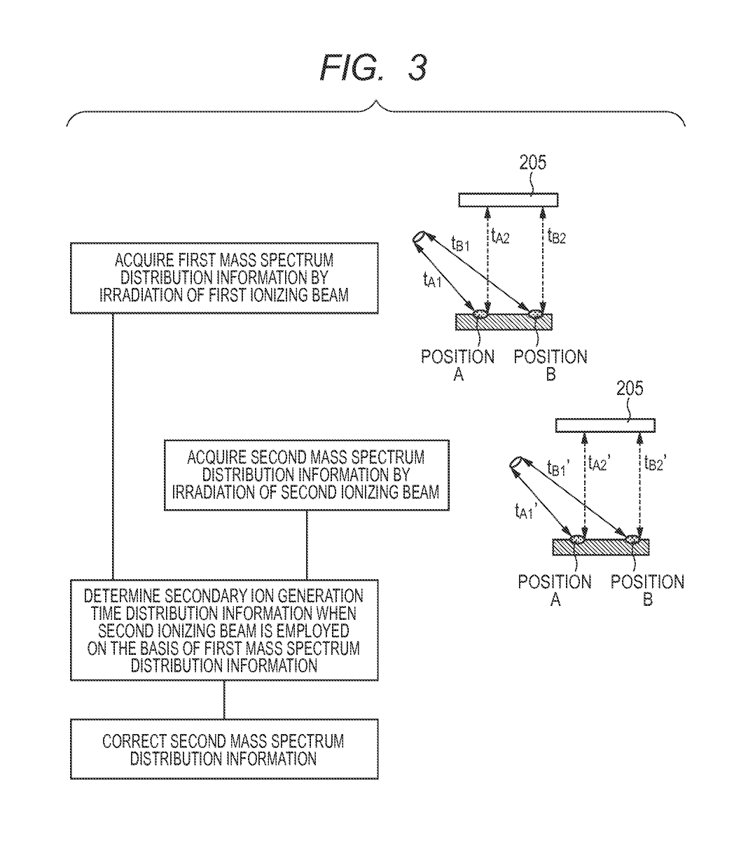

Now, an embodiment of mass spectrum distribution information acquisition method according to the present invention will be described in greater detail below by referring to FIG. 3.

Referring to FIG. 3, assume that the duration of time from the time when the first ionizing beam is emitted to the time when the beam arrives at position A on the specimen surface is t_{A1} and the duration of time from the time when the first ionizing beam is emitted to the time when the beam arrives at position B is t_{B1}. Also assume that the duration of time from the time when ion X is generated at position A to the time when the ion X arrives at the detector is t_{A2} and the duration of time from the time when the same ion X is generated at position B to the time when the ion X arrives at the detector is t_{B2}. Assume, on the other hand, the duration of time from the time when the second ionizing beam is emitted to the time when the beam arrives at position A is t_{A1}′ and the duration of time from the time when the second ionizing beam is emitted to the time when the beam arrives at position B is t_{B1}′. Further assume that the duration of time from the time when ion X is generated at position A to the time when the ion X arrives at the detector is t_{A2}′ and the duration of time from the time when the same ion X is generated at position B to the time when the ion X arrives at the detector is t_{B2}′.

The first mass spectrum distribution information is acquired by irradiation of the first ionizing beam. Then, attention is paid to an arbitrary peak that is commonly detected from all the positions in the spectrum at each and every position in the two-dimensional distribution contained in the first mass spectrum distribution information. Thereafter, the time of detection of the peak at each of the positions (detection time distribution) is determined. If the peak is attributable to ion X, the detection time at position A is expressed as (t_{A1}+t_{A2}) and the detection time at position B is expressed as (t_{B1}+t_{B2}). As described above, the velocity of the first ionizing beam is such that the difference of flight time of the first ionizing beam that arises due to the difference of route of flight down to the specimen surface can be disregarded and hence t_{A1}=t_{B1} can safely be regarded as true.

The detection time of an arbitrary peak may be the detection time of the peak top. Alternatively, the detection time may be the detection time of the rising edge of the peak or the falling edge of the peak.

As arbitrary peak, the peak of a substance adsorbed to the specimen surface such as the peak of H⁺, the peak of CH₃⁺ or the peak of a substance that is contained in the specimen may be employed. Alternatively, the specimen surface may be coated with metal or an organic compound in advance and the peak of the substance used for the coating may be employed. With ordinary spectrums, the peak of H⁺ is the peak that will be detected first and hence will be detected with ease by automatic detection. Therefore, the peak of H⁺ may preferably be employed.

The coating substance may be formed in advance on the specimen or the apparatus may be provided with a coating mechanism in the inside thereof and the coating operation may be conducted after introducing the specimen into the apparatus. Examples of coating techniques that can be used for the purpose of the present invention include spin coating, sputtering and vacuum evaporation.

The second mass spectrum distribution information is acquired by irradiation of the second ionizing beam and the detection time distribution of peak X in the second spectrum distribution information is acquired in the above-described manner. Namely, the detection time at position A can be considered to be (t_{A1}′+t_{A2}′) and the detection time at position B can be considered to be (t_{B1}′+t_{B2}′). Thus, the duration of time from the time when ion X is generated to the time when the ion X arrives at the detector remains the same for all ions X regardless if ions X are generated by different ionizing beams or not. In other words, t_{A2}=t_{A2}′ and t_{B2}=t_{B2}′.

Then, the difference between the detection time distribution of peak X in the second spectrum distribution information and the detection time distribution of peak X in the first spectrum distribution information (the difference at each position) is determined.

With the difference information of detection time distributions that is acquired in this way, relative secondary ion generation time distribution information for an instance where the second ionizing beam is employed can be obtained by using the value of an arbitrary position as reference value and subtracting the reference value from the value at each position.

For example, referring to FIG. 3, the difference of detection time at position A is (t_{A1}′+t_{A2}′)−(t_{A1}+t_{A2}) and the difference of detection time at position B is (t_{B1}′+t_{B2}′)−(t_{B1}+t_{B2}). If the value at position A is selected as reference value, the difference of ion generation time between position A and position B, or the delay at position B relative to position A t_{B}_{_{—}}_{delay}, is expressed as t_{B}_{_{—}}_{delay}=[(t_{B1}′+t_{B2}′)−(t_{B1}+t_{B2})][(t_{A1}′+t_{A2}′)−(t_{A1}+t_{A2})]. Since t_{A1}=t_{B1}, t_{A2}=t_{A2}′ and t_{B2}=t_{B2}′, t_{B}_{_{—}}_{delay}=t_{B1}′−t_{A1}′, which is the time lag of the ion generation time at position B relative to the ion generation time at position A that arises when the second ionizing beam is employed.

The delay distribution of secondary ion generation time in the second mass spectrum distribution information can be corrected by use of the secondary ion generation time distribution information that is obtained when the second ionizing beam is employed. Differently stated, the result obtained by subtracting the secondary ion generation time distribution information from the time information of the second mass spectrum distribution information is the corrected information.

An instance of correcting the second mass spectrum information at position B by using position A as reference will be described below. The second mass spectrum information at position B can be expressed as two-dimensional information (tₙ, Iₙ) of time tₙ and intensity Iₙ. Note that n (=1, 2, 3, . . . ) is the index for indicating different peaks of the spectrum. By correcting the time lags between the ion generation times at position A and the ion generation times at position B, the second mass spectrum information at position B is obtained as (tₙ−t_{B}_{_{—}}_{delay}, Iₙ).

Thus, when a primary ion beam (the second ionizing beam) having a thickness is made to strike the surface of a specimen obliquely, the fall of mass resolution due to variations of secondary ion generation time can be corrected so that a highly reliable mass distribution image can be acquired at the time when the mass distribution image is reconstructed from mass spectrum information.

### EXAMPLE

Now, the present invention will be described further by way of a specific example. However, the present invention is by no means limited to the example.

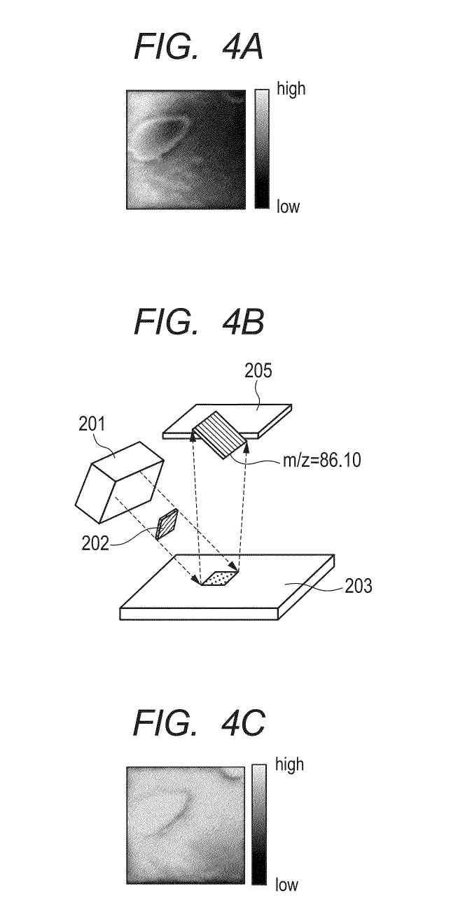

Now, the example of the present invention will be described below by referring to FIG. 1 and FIGS. 4A through 4C.

A glass substrate having an ITO evaporation layer (available from Sigma-Aldrich) is employed as substrate 4. A frozen cut piece of mouse liver (thickness: 5 microns) is placed on the substrate and made to adhere to the substrate as it becomes molten.

A laser is employed for the first ionizing beam irradiation unit 1 to output a first ionizing beam. The laser may be a YAG laser or the like. The unit 1 outputs a laser beam defocused to represent a beam diameter of about 1 mmφ. The unit 1 outputs a pulsed laser beam with a pulse period not greater than several ns. The unit 1 is made to emit a laser beam so as to strike the surface of the substrate 4 at an angle of 45°.

The second ionizing beam irradiation unit 2 is made to output a beam of primary ions. Primary ions may be Ga⁺, Bi⁺, Bi₂⁺ or the like. The unit 2 outputs a primary ion beam defocused to represent a beam diameter of about 500 μmφ. The unit 2 outputs a pulsed primary ion beam with a pulse period of not greater than several ns. The unit 2 is made to emit a primary ion beam so as to strike the substrate at an angle of 45°.

The ion detection unit 9 has a time-of-flight mass spectrometry section 7 and a secondary ion detection section 8. An area of about several hundred ∥m square is selected as measurement area and imaging pixels of 256×256 or the like are selected for each mass spectrometry image. The secondary ion extraction electrode 6 and the substrate 4 are arranged so as to be separated from each other by a gap of several mm and a secondary ion extraction voltage of several kV is applied between the secondary ion extraction electrode 6 and the substrate 4.

The secondary ion detection section 8 is constructed by combining a micro channel plate (MCP) and a delay line detector so as to detect secondary ions generated from the specimen as a result of the irradiations of the first and second ionizing beams. The mass spectrum distribution information acquisition unit 10 outputs the data relating to positions and masses that are acquired by the two-dimensional ion detection section 8 onto a memory.

Now, the process of correcting mass spectrum distribution information of this example will be described below. The mass spectrum distribution information correction unit 11 determines the peak top detection time of the first peak (H⁺ peak) obtained at each detected position for each piece of mass spectrum distribution information output from the mass spectrum distribution information acquisition unit 10 and outputs the determined peak top detection time onto the memory.

Additionally, the mass spectrum distribution information correction unit 11 determines the difference between the peak top detection time information on the first peak (H⁺ peak) acquired by irradiating the first ionizing beam onto the specimen and the peak top detection time information on the first peak (H⁺ peak) acquired by irradiating the second ionizing beam onto the specimen for each detected position. The mass spectrum distribution information correction unit 11 selects the information on the center position of the detector as reference value in the determined difference information on detection time distributions and subtracts the reference value from the value at each detected position to acquire relative secondary ion generation time distribution information for an instance where the second ionizing beam is employed and output the information onto the memory.

Then, the result of subtracting the secondary ion generation time distribution information from the time information of the second mass spectrum distribution information is output onto the memory as corrected second mass spectrum distribution information.

FIG. 4A illustrates the data output as mass distribution image that are obtained by extracting the integrated signal intensity within the range of m/z of 86.10±0.1 from the spectrum at each detected position in the mass spectrum distribution information acquired by using the second ionizing beam.

In FIG. 4A, the image is light (and hence the detected intensity is high) at the left side while the image is dark (and hence the detected intensity is low) at the right side. FIG. 4B schematically illustrates how the data are detected for the image. More specifically, FIG. 4B illustrates that the detector detects a substance with m/z=86.10 at the left side but the substance with m/z=86.10 at the right side has not arrived at the detector yet. Then, as a result, an image that is light at the left side and dark at the right side is displayed.

FIG. 4C illustrates the data output as mass distribution image that are obtained by extracting the integrated signal intensity within the range of m/z =86.10 ±0.1 from the spectrum at each detected position in the corrected second mass spectrum distribution information. It will be seen that the proper distribution of a substance with m/z=86.10 can more accurately be displayed as image by correcting the variance of secondary ion generation time.

As illustrated by the above-described example, the mass spectrum distribution information acquisition method of the present invention can reduce the mass error attributable to the variance of arrival time of second ionizing beam (primary ion beam) so that a highly reliable mass distribution image can be obtained by means or the method. Additionally, a mass distribution measurement apparatus that is adapted to output the obtained data to the outside as a mass distribution image can be formed according to the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computer system, an optical disk (such as a compact disk (CD), a digital versatile disk (DVD), or a Blue-Ray Disk (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-225694, filed Oct. 30, 2013, which is hereby incorporated by reference herein in its entirety.

What is claimed is:

1. A projection TOF mass spectrum distribution information acquisition method comprising:
a first step of irradiating a first ionizing beam onto a surface of a specimen and acquiring first mass spectrum distribution information on secondary ions generated from the specimen as a result of irradiation of the first ionizing beam;
a second step of irradiating a second ionizing beam onto the surface of the specimen and acquiring second mass spectrum distribution information on secondary ions generated from the specimen as a result of irradiation of the second ionizing beam; and
a third step of correcting the second mass spectrum distribution information on the basis of the first mass spectrum distribution information;
the third step including correcting a delay distribution of secondary ion generation times in the second mass spectrum distribution information on the basis of the first mass spectrum distribution information.

2. The method according to claim 1, wherein the third step includes determining arrival time distribution information of the second ionizing beam at the specimen from a difference between the first mass spectrum distribution information and the second mass spectrum distribution information.

3. The method according to claim 1, wherein the velocity of the first ionizing beam is not less than 1×10⁶ m/s.

4. The method according to claim 1, wherein the velocity of the first ionizing beam is greater than the velocity of the second ionizing beam.

5. The method according to claim 4, wherein the first ionizing beam is a beam formed by using an ion species that is different from the ion species of the second ionizing beam.

6. The method according to claim 4, wherein the first ionizing beam is a beam formed by using an ion species that is the same as an ion species of the second ionizing beam.

7. The method according to claim 1, wherein the first ionizing beam is a pulsed laser beam or a pulsed electron beam.

8. The method according to claim 1, wherein the second ionizing beam is a pulsed ion beam.

9. The method according to claim 8, wherein the second ionizing beam is a beam of cluster ions.

10. The method according to claim 9, wherein the cluster ions are selected from metal cluster ions, gas cluster ions, carbon based cluster ions, and water based cluster ions.

11. The method according to claim 1, wherein the first mass spectrum distribution information is obtained for a substance arranged on the specimen.

12. The method according to claim 11, wherein the first mass spectrum distribution information is obtained for a substance adsorbed onto the surface of the specimen.

13. A projection TOF mass distribution measurement apparatus comprising:
a specimen stage for receiving a specimen to be mounted thereon;
a first ionizing beam irradiation unit for irradiating a first ionizing beam onto the specimen mounted on the specimen stage;
a second ionizing beam irradiation unit for irradiating a second ionizing beam onto the specimen mounted on the specimen stage;
a secondary ion detection unit for separating secondary ions generated from the specimen as a result of irradiation of the ionizing beams by mass-to-charge ratio and two-dimensionally detecting the secondary ions;
a mass spectrum distribution information acquisition unit for acquiring mass spectrum distribution information from a secondary ion detection signal output from the secondary ion detection unit;
a mass spectrum distribution information correction unit for correcting the mass spectrum distribution information output from the mass spectrum distribution information acquisition unit; and
an output unit for outputting mass spectrum distribution information, the apparatus being configured to:
acquiring first mass spectrum distribution information by irradiation of the first ionizing beam;
acquiring second mass spectrum distribution information by irradiation of the second ionizing beam;
correcting a delay distribution of secondary ion generation times in the second mass spectrum distribution information on the basis of the first mass spectrum distribution information; and
outputting the corrected second mass spectrum distribution information from the output unit.

14. The apparatus according to claim 13, wherein the first ionizing beam is a pulsed ion beam.

15. The apparatus according to claim 13, wherein the first ionizing beam is a pulsed laser beam or a pulsed electron beam.

16. The apparatus according to claim 13, wherein the second ionizing beam is a pulsed ion beam.

17. The apparatus according to claim 16, wherein the second ionizing beam is a beam of cluster ions.

18. The apparatus according to claim 17, wherein the cluster ions are selected from metal cluster ions, gas cluster ions, carbon based cluster ions, and water based cluster ions.

19. The apparatus according to claim 13, wherein a single ionizing beam irradiation unit is employed both as the first ionizing beam irradiation unit and as the second ionizing beam irradiation unit.

20. The apparatus according to claim 13, wherein the secondary ion detection unit comprises an extraction electrode for accelerating secondary ions, a flight tube in which accelerated secondary ions fly at a constant velocity and a two-dimensional ion detection section to which secondary ions are projected after flying through the flight tube.
